(19) United States
(12) Patent Application Publication
(10) Pub. No.: US 2014/0173225 A1
(43) Pub. Date: Jun. 19, 2014

(54) REDUCING MEMORY ACCESS TIME IN PARALLEL PROCESSORS

(71) Applicant: ADVANCED MICRO DEVICES, INC., Sunnyvale, CA (US)

(72) Inventors: Niladrish Chatterjee, Salt Lake City, UT (US); James O'Connor, Austin, TX (US); Gabriel Loh, Bellevue, WA (US); Nuwan Jayasena, Sunnyvale, CA (US)

(73) Assignee: ADVANCED MICRO DEVICES, INC., Sunnyvale, CA (US)

(21) Appl. No.: 13/719,710

(22) Filed: Dec. 19, 2012

(51) Int. Cl. G06F 12/00

(52) U.S. Cl. CPC G06F 12/00
USPC 711/158

(57) ABSTRACT

Apparatus, computer readable medium, and method of servicing memory requests are presented. A first plurality of memory requests are associated together, wherein each of the first plurality of memory requests is generated by a corresponding one of a first plurality of processors, and wherein each of the first plurality of processors is executing a first same instruction. A second plurality of memory requests are associated together, wherein each of the second plurality of memory requests is generated by a corresponding one of a second plurality of processors, and wherein each of the second plurality of processors is executing a second same instruction. A determination is made to service the first plurality of memory requests before the second plurality of memory requests and the first plurality of memory requests is serviced before the second plurality of memory requests.

### TECHNICAL FIELD

The disclosed embodiments are generally directed to scheduling memory accesses, and in particular, to scheduling memory accesses for single instruction multiple data parallel processors.

### BACKGROUND

A parallel processing computer may have multiple processors that perform the same instruction on different data. This type of parallel processing computer is often called a single instruction multiple data (SIMD) parallel processing computer. The collection of processors is often 4, 8, 16, or 32 processors. A different number of processors may be used. The processors may execute instructions as follows. An instruction is selected that all of the processors will execute. Memory locations are selected for each of the processors to execute the instruction. For example, eight processors may add the numerical value of one (1) to a consecutive sequence of memory locations. The eight processors need to retrieve the data from the memory locations to add the value of one (1). All of the processors wait until all of the other processors have finished performing the instruction before moving to the next instruction.

Because none of the processors moves to the next instruction until all of the processors are finished with the last instruction, the parallel processing computer can be slowed down by waiting for memory requests to be satisfied for all the processors. For example, seven of eight processors may have completed adding one (1) to a memory location and all seven of the processors may be waiting for the eighth processor to receive the data from memory so that the eighth processor can add one (1) to the data.

An instruction of a sequence of instructions being executed in lock-step by a group of processors of a SIMD parallel processing computer is often called a wave front. The group of processors of the SIMD executing an instruction in lock-step may generate a group of memory requests. Often, graphic processing units (GPUs) are SIMD parallel processing computers.

Therefore, there is a need in the art for an apparatus, computer readable medium, and method of reducing memory access time for parallel processors.

### SUMMARY OF EMBODIMENTS

Some embodiments provide a method of servicing memory requests. The method includes associating a first plurality of memory requests together, wherein each of the first plurality of memory requests is generated by a corresponding one of a first plurality of processors, and wherein each of the first plurality of processors is executing a first same instruction. The method includes associating a second plurality of memory requests together, wherein each of the second plurality of memory requests is generated by a corresponding one of a second plurality of processors, and wherein each of the second plurality of processors is executing a second same instruction. The method includes determining to service the first plurality of memory requests before the second plurality of memory requests and servicing at least some of the first plurality of memory requests before at least some of the second plurality of memory requests based on the determination.

Some embodiments provide an apparatus for servicing memory requests. The apparatus includes a memory, a first single instruction multiple data (SIMD) plurality of processors configured to generate a corresponding first plurality of memory requests, a second SIMD plurality of processors configured to generate a corresponding second plurality of memory requests, a memory controller comprising a memory request buffer configured to store the first plurality of memory requests and the second plurality of memory requests, and configured to service the first plurality of memory requests and the second plurality of memory requests, and a scheduling control configured to determine whether to service the first plurality of memory requests or the second plurality of memory requests first.

Some embodiments provide a method of servicing memory requests. The method includes associating a first plurality of memory requests together, wherein each of the first plurality of memory requests is generated by a corresponding one of a first plurality of processors, and wherein each of the first plurality of processors is executing a first same instruction. The method includes associating a second plurality of memory requests together, wherein each of the second plurality of memory requests is generated by a corresponding one of a second plurality of processors, and wherein each of the second plurality of processors is executing a second same instruction. The method includes determining to service the first plurality of memory requests before the second plurality of memory requests and raising a first priority of the first plurality of memory requests higher than a second priority of the second plurality of memory requests based on the determination.

Some embodiments provide a computer readable non-transitory medium including instructions which when executed in a processing system cause the processing system to execute a method for servicing memory requests. The method includes associating a first plurality of memory requests together, wherein each of the first plurality of memory requests is generated by a corresponding one of a first plurality of processors, and wherein each of the first plurality of processors is executing a first same instruction. The method includes associating a second plurality of memory requests together, wherein each of the second plurality of memory requests is generated by a corresponding one of a second plurality of processors, and wherein each of the second plurality of processors is executing a second same instruction. The method includes determining to service the first plurality of memory requests before the second plurality of memory requests and servicing the first plurality of memory requests before the second plurality of memory requests.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented;

FIG. 2 is a schematic diagram illustrating an example of an apparatus for reducing memory access time for parallel processors, in accordance with some embodiments;

FIG. 3 is a schematic diagram illustrating an example of an apparatus for reducing memory access time for parallel processors, in accordance with some embodiments;

FIG. 4 is a schematic diagram illustrating an example of an apparatus for reducing memory access time for parallel processors, in accordance with some embodiments; and

FIG. 5 is a schematic diagram illustrating an example method for reducing memory access time for parallel processors, in accordance with some embodiments.

### DETAILED DESCRIPTION OF EMBODIMENT(S)

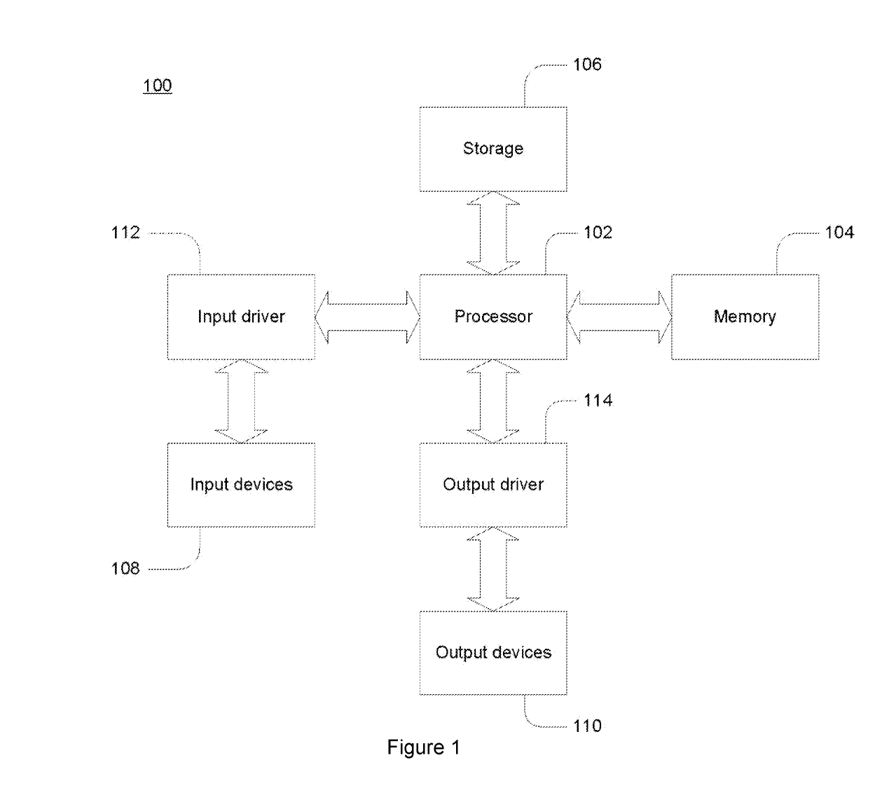

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The GPU may include two or more SIMD processing units. The memory 104 may be located on the same die as the processor 102, or may be located separately from the processor 102. The memory 104 may include a volatile or non-volatile memory, for example, random access memory (RAM), dynamic RAM (DRAM), or a cache. The memory 104 may include one or more memory controllers. The memory controller may be located on the same die as the CPU or another die.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

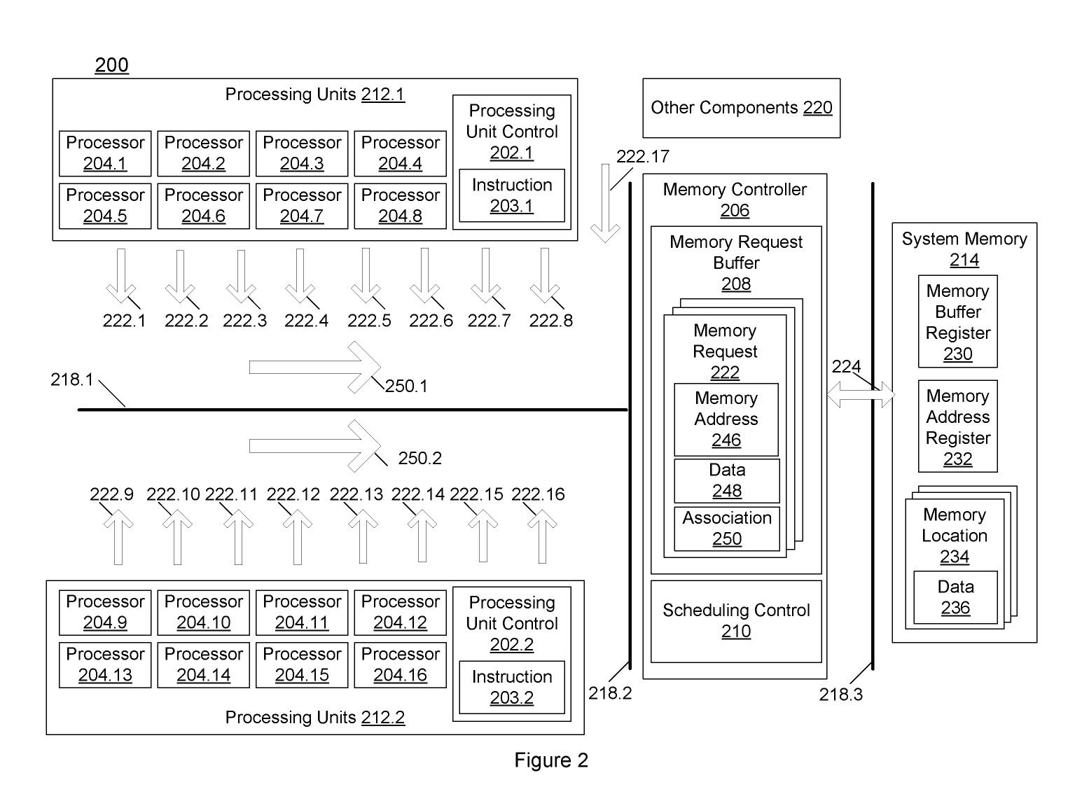

FIG. 2 is a schematic diagram illustrating an example of an apparatus for reducing memory access time for parallel processors 200, in accordance with some embodiments. FIG. 2 illustrates processing units 212, other components 220, data buses 218, memory controller 206, memory requests 222, memory requests of wave fronts 250, retrieve and store requests 224, and system memory 214.

The processing units 212 and other components 220 generate memory requests 222 that are sent by the data buses 218 to the memory controller 206, which services the memory requests 222. The memory requests 222 generated by the processing units 212 are associated together, and the memory controller 206 may use this association to determine which memory requests 222 to service first.

The processing units 212 may include processing unit control 202 and processors 204. The processing unit control 202 may include an instruction 203. The processing unit control 202 may be a controller that retrieves instructions 203 and decodes the instructions 203 for the processors 204 to execute. An example of the processors 204 are arithmetic and logic units (ALUs). The processors 204 may include floating point operations. There may be one, two, or more than two processors 204. The processing units 212 may be configured so that each processor 204 of the same processing unit 212 executes the instruction 203 at the same time on different data 248. The processing units 212 may be configured so that each of the processors 204 waits to proceed to a next instruction until each of the other processors 204 has completed executing the instruction 203. In some embodiments, the processing units 212 are configured so that a processor 204 may proceed with a limited number of next instructions before each of the other processors 204 have completed executing the instruction 203.

In examples, the processing units 212 may generate fewer memory requests 222 than processors 204 due to computer instructions indicating not to use all the processors 204, or memory requests 222 may be satisfied by a cache memory so that the memory requests 222 are not made to the system memory 214.

Optionally, the system 200 may include other components 220 that may make memory requests 222 to the memory controller 206 such as a central processing unit (CPU), and input devices 108 and output devices 110.

The data buses 218 enable data to be sent from and to the processing units 212, the memory controller 206, the other components 220, and the system memory 214. The data buses 218 may include a control bus, data bus, and address bus. The information sent on the data buses 218 may include memory requests 222, the data in the system memory 214, and messages sent between processing units 212, memory controller 206, other components 220, and system memory 214.

The memory controller 206 may include a memory request buffer 208 and a scheduling control 210. The memory request buffer 208 may include one or more memory requests 222 that are waiting to be serviced. The memory requests 222 may include memory address 246, data 248, and, optionally, an association 250. The memory address 246 may be an address which indicates which memory location 234 from which to retrieve the data 236, or in which memory location 234, to store data 248. Optionally, the memory request 222 includes an association 250. Association 250 indicates a group of memory requests 222 that are associated together with one another. For example, each of the memory requests 222.9 through 222.16 of the wave front 250.2 may be associated with one another by having a same association 250.

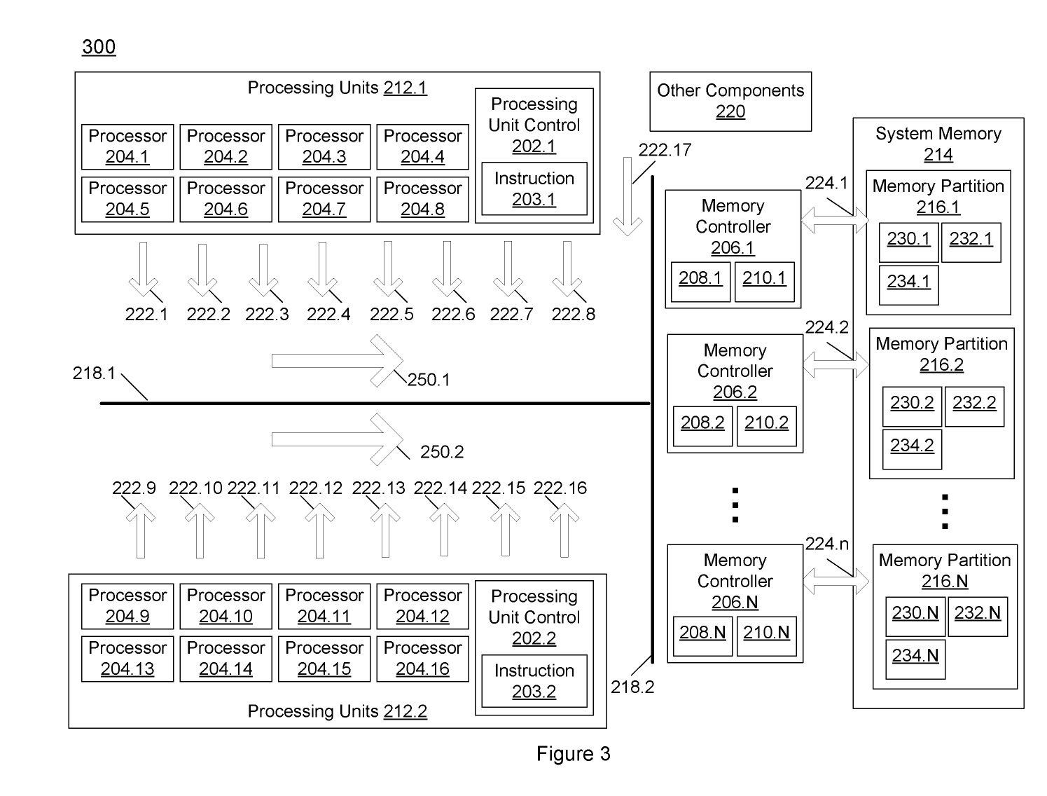

Association 250 may be several bits used to represent a number for the association 250. The association 250 may be unique or may be a value that is not likely to be a duplicate value. Association 250 may be set by the memory controller 206, other components 220, or processing units 212. Association 250 may be indicated by a location of the memory requests 222 in the memory request buffer 208. In embodiments, the association 250 may be set based on a time memory requests 222 arrive at one or more memory controllers 206 (see FIG. 3 for more than one memory controller 206).

Memory requests 222.1 through 222.8 are generated by processors 204.1 through 204.8, respectively. Association 250.1 represents memory requests 222.1 through 222.8. Memory requests 222.9 through 222.16 are generated by processors 204.9 through 204.16, respectively. Association 250.2 represents memory requests 222.9 through 222.16. Memory request 222.17 is generated by other components 220. Memory request 222.1 through 222.16 may not include the association 250. The association 250 may be added after the memory request 222 is received by the memory controller 206.

The scheduling control 210 may determine the order in which the memory requests 222 received by the memory controller 206 are serviced. The scheduling control 210 may determine to service memory requests 222 differently based on the association 250. For example, the scheduling control 210 may determine to service all the memory requests 222 with the same association 250 before other memory requests 222, which may be memory requests 222 with a different association 250. For example, the scheduling control 210 may determine to service the wave front 250.1 (memory requests 222.1 through 222.8) before the wave front 250.2 (memory requests 222.1 through 222.8).

The scheduling control 210 may determine to service memory requests 222 differently based on whether or not the memory requests 222 are in a same row of system memory 214 as other memory requests 222.

The scheduling control 210 may determine to service the memory requests 222 having the same association 250 before other memory requests 222, which may be associated with a second association 250, or raise the priority of the memory requests 222 having the same association 250 if the number of memory requests 222 with the same association 250 is below a threshold number. The threshold number may be set statically or dynamically, and the threshold number may be based on the number of processors 204 of the processing units 212. For example, if there are 16 processors 204 the threshold number may be 3 so that the 3 or fewer memory requests 222 having an association would be serviced before other memory requests 222. The threshold number may be based on the state of the memory controller 206, which may include how full the memory request buffer 208 is.

The scheduling control 210 may determine to service the memory requests 222 having the same association 250 before other memory requests 222, which may be associated with a second association 250, or raise the priority of the memory requests 222 having the same association 250 if a number of row hits of the memory requests 222 having the same association is greater than a threshold number or greater than a second number of row hits of other memory requests 222 associated with a second association 250 plus a second threshold number.

The scheduling control 210 may determine to service the memory requests 222 having the same association 250 before other memory requests 222, which may be associated with a second association 250, or raise the priority of the memory requests 222 having the same association 250 if a first number of row hits of the memory requests 222 having the same association 250 is approximately equal to a second number of row hits of the memory requests 222 having the same second association 250, and an age of the memory requests 222 having the same association 250 is older than a second age of the memory requests 222 having the same second association 250.

The scheduling control 210 may compare a first estimated time to service the memory requests 222 having the same association 250 with a second estimated time to service the memory requests 222 having the same second association 250. The scheduling control 210 may determine to service the memory requests 222 having the same association 250 before other memory requests 222, which may be associated with a second association 250, or raise the priority of the memory requests 222 having the same association 250 based on the comparison. For example, if the first estimated time is below a threshold value compared with the second estimated time, the scheduling control 210 may determine to service memory requests 222 having the same association 250 before memory requests 222 having the same second association 250.

The scheduling control 210 may compare a first time in a memory request buffer for the memory requests 222 having the same association 250 with a second time in a memory request buffer for the memory requests 222 having the same second association 250. The scheduling control 210 may determine to service the memory requests 222 having the same association 250 before other memory requests 222, which may be associated with a second association 250, or raise the priority of the memory requests 222 having the same association 250 based on the comparison. For example, if the first time is greater than the second time plus a threshold value, then the scheduling control 210 may service the memory requests 222 having the same association 250 before other memory requests 222, which may be associated with a second association 250, or may raise the priority of the memory requests 222 having the same association 250.

The scheduling control 210 may determine to service the memory requests 222 having the same association 250 before other memory requests 222, which may be associated with a second association 250, or raise the priority of the memory requests 222 having the same association 250 if most of the memory requests 222 having the same association 250 have already been serviced, or if a threshold number of the memory requests 222 having the same association 250 have already been serviced.

The scheduling control 210 may determine to service the memory requests 222 with the highest priority. The scheduling control 210 may be implemented in software, hardware, firmware, or microinstructions. The scheduling control 210 may be located in a different place than on the memory controller 206. For example, the scheduling controller 210 may be located on a same die as a component 220 (e.g., a CPU), or on a different die in communication with the memory controller 206.

The system memory 214 may include a memory buffer register 230, memory address register 232, and memory locations 234. Memory locations 234 are places where data 236 is stored. For example, a memory location 234 may be 32 bits long. The data 236 is the value of either 1 or 0 of each of the 32 bits. Each memory location 234 has an address. The memory address register 232 may be a place where an address associated with a memory location 234 may be placed. The memory buffer register 230 may operate differently for reads and writes. For memory reads, an address is placed in memory address register 232 and then the data 236 of the memory location 234 with the address in memory address register 232 is placed in the memory buffer register 230. For memory writes, an address is placed in memory address register 232 and then the data in the memory buffer register 230 is placed in the memory location 234 with the address in memory address register 232. Different ways of reading from and writing to system memory 214 may be used.

Retrieve and store requests 224 are requests to the system memory 214 from the memory controller 206. The memory controller 206 is configured to retrieve data 236 from and to store data 248 in system memory 214. In some embodiments, to retrieve data 236 from system memory 214, a memory address 246 from a memory request 222 is placed in the memory address register 232. The data 236 from the memory location 234 associated with the memory address 246 in the memory address register 232, is then retrieved and placed in the memory buffer register 230. In some embodiments, a row of data 236 of memory locations 234 associated with the memory address 246 is retrieved from system memory 214, or stored to system memory 214. Storing data 248 to system memory 214 is performed as follows. The memory address 246 is placed in the memory address register 232 and the data 248 is placed in the memory buffer register 230. The data 248 in the memory buffer register 230 is then written to the data 236 of the memory location 234 corresponding to the memory address in the memory address register 232.

The system memory 214 may be random access memory (RAM). The RAM may be other types of memory such as dynamic random access memory, static random access memory, or other types of memory that can store and retrieve data for use by processing units 212 and other components 220. In some embodiments, there may be one or more caches associated with the system memory 214. For example, there may be a cache associated with the processing units 212 that stores values of the system memory 214.

In operation, the processing unit control 202.1, fetches an instruction 203.1 for the processing units 212.1 through 212.8 to execute. The processing units 212.1 through 212.8 execute each instruction 203.1 in lock-step, which may be referred to as a wave front. If the instruction 203.1 requires memory access, the processing units 212.1 through 212.8 generate memory requests 222.1 through 222.8 to the memory controller 206. The memory requests 222.1 through 222.8 correspond to wave front 250.1, which represents the group of memory requests 222.1 through 222.8. The memory requests 222.1 through 222.8 may be buffered in the memory request buffer 208. Processing units 212.2 operate in a corresponding fashion to processing units 202.1.

The scheduling control 210 determines the order the memory requests are serviced. The memory controller 206 takes one or more memory requests 222 and accesses the system memory 214 to service the memory request 222. The memory request 222 may request that data 248 be stored at a memory location 234 corresponding to memory address 246, or the memory request 222 may request that the data 236 already stored at the memory location 234 be retrieved from the system memory 214. The system memory 214 may be accessible by a two-step process where a row of memory locations, for example, 1024, may be made available via a “row access” step followed by accesses to individual memory locations within the row in “column access” steps. Therefore the scheduling control 210 may order the memory requests so that multiple memory requests that can be satisfied with a single row access to the system memory 214 may be serviced together. The scheduling control 210 may determine to satisfy one or more of the memory requests 222.1 through 222.8 before a memory request 222 that is not associated with the memory requests 222.1 through 222.8. For example, a memory request 222 from other components 220 that may not be associated with other memory requests 222, or a memory request 222.9 through 222.16 that is associated with a different group of memory requests.

In examples, the scheduling controllers 210 may be configured to satisfy memory requests 222 with a lower priority before memory requests 222 with a higher priority if the memory requests 222 with the lower priority can be serviced without retrieving or storing additional memory locations 234.

FIG. 3 is a schematic diagram illustrating an example of an apparatus for reducing memory access time for parallel processors 300. FIG. 3 is similar to FIG. 2, but includes multiple memory controllers 206 and system memory 214 divided into a plurality of memory partitions 216. Memory partitions 216 may be portions of the system memory 214 for memory locations 234 between two memory addresses. For example, memory partition 216.2 may contain memory locations 234 for memory addresses from 256 megabytes to 512 megabytes. In some embodiments, memory addresses are interleaved among the memory partitions at some granularity. For example, in a system with 4 partitions, memory addresses 0 through 31 may map to the first partition, addresses 32 through 63 may map to the second partition, addresses 64 through 95 may map to the third partition, addresses 96 through 127 may map to the forth partition, addresses 128 through 159 may map to the first partition and so on. Each of the memory partitions 216 has a corresponding memory controller 206 that services the memory requests 222 for that memory partition 216. For example, memory controller 206.2 services memory requests 222 for the memory locations 234 that correspond to memory partition 216.2. The memory partitions 216 may be independent so that the different memory partitions 216 can be accessed in parallel.

In operation, the memory requests 222 may be sent to different memory controllers 206. For example, memory request 222.9 may be sent to memory controller 206.1, and memory request 222.10 may be sent to memory controller 206.2 based on the memory address 246 of the memory request 222.

The scheduling controllers 210 of the memory controllers 206 may be configured to notify one another when a memory controller 206 determines to service the memory requests 222 having a same association 250 before other memory requests 222. For example, continuing with the example above, memory controller 206.1 may notify memory controller 206.2 that the memory request 222.9 having the association 250 has been serviced. Memory controller 206.2 may respond by determining to service memory request 222.10 rather than a different memory request 222, such as a memory request 222.1, or memory request 222.17. The memory controller 210 may notify other memory controllers 206 of the policy used to service or raise a priority of memory requests 222. The memory controller 206 may notify the other memory controllers 206 of a confidence index that indicates how confident the memory controller 206 is regarding servicing or raising the priority of a memory request 222.

The scheduling controllers 210 may be configured to prioritize memory requests 222 and service memory requests with a higher priority before a lower priority memory request 222. Memory requests from a component 220 (e.g., a CPU) may be assigned a higher priority than memory requests 222 from a direct memory access (DMA) controller, or from a processing unit 212. The scheduling controllers 210 may service memory requests 222 before other memory requests 222 based on how long a memory request 222 has been waiting to be serviced, which may be referred to as the age of the memory request 222.

The memory controllers 206 may be configured to notify other memory controllers 206 when all memory requests 222 having a same association 250 have been serviced for that memory controller 206. The memory controllers 206 may be configured to notify other memory controllers 206 when a first memory request 222 having an association 250 have been serviced for that memory controller 206.

The memory controllers 206 may be configured to notify other memory controllers 206 when a look ahead by the scheduling controller 210 indicates that memory requests 222 having a same association 250 will be serviced by the memory controller 206 soon. One or more of the memory controllers 206 may stop making service decisions based on the association 250 if the memory request buffer 208 of one or more memory controllers 206 reaches a threshold level.

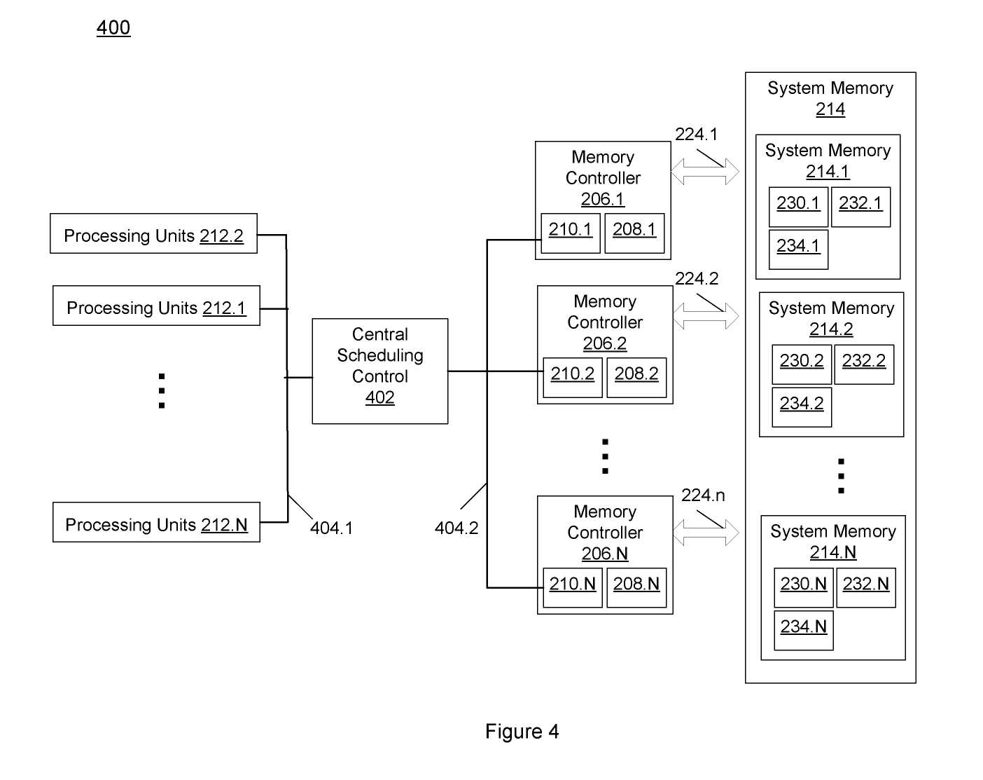

FIG. 4 is a schematic diagram illustrating an example of an apparatus for reducing memory access time for parallel processors 400. Illustrated in FIG. 4 is central scheduling control 402, memory controllers 206, system memory 214, and communication lines 404. The memory controllers 206 and system memory 214 are similar to those described in conjunction with FIG. 3. The central scheduling control 210 may send information to the memory controllers 206 regarding an order in which the memory requests 222 received by the memory controllers 206 should be serviced by the memory controllers 206.

The central scheduling control 402 may be configured to receive information from the processing units 212. For example, the processing units 212 may associate memory requests 222 together and notify the central scheduling control 402 of the association 250. In an example, the processing units 212 may notify the central scheduling control 204 of the number of memory requests 222 in the association 250. The processing units 212 may communicate with the central scheduling control 402 via communication lines 404.1. The communication lines 404 may be buses 218, or different means of communicating such as dedicated lines.

The central scheduling control 402 may be configured to send and receive information to the memory controllers 206 via communication lines 404.2. The central scheduling control 402 may be configured to receive information regarding the contents of the memory request buffer 208 of each of the memory controllers 206. For example, the central scheduling control 402 may receive information regarding a number of memory requests 222 in each of the memory request buffers 208. The central scheduling control 402 may receive information regarding the association 250 of the memory requests 222 in the memory request buffers 208 of the memory controllers 206. The central scheduling control 402 may receive information regarding a number of memory requests 222 of an association 250 in a memory request buffer 208 of a memory controller 206.

The central scheduling control 402 may be configured to monitor the memory requests 222 having an association 250, and to select an association 250, and notify the memory controllers 206 to raise the priority of memory requests 222 having the association 250, or to service the memory requests 222 having the association 250 before other memory requests 222.

The central scheduling control 402 may be configured to monitor the memory requests 222 having an association 250 that have been serviced, and notify the memory controllers 206 to raise the priority of remaining memory requests 222 having the association 250, or to service the memory requests 222 having the association 250 before other memory requests 222, when a threshold level of the memory requests 222 having an association 250 has been serviced. For example, after fifty percent of the memory requests 222 having an association 250 have been serviced.

The central scheduling control 402 may notify the memory controllers 206 of a confidence index for scheduling notifications, which indicates how confident the central scheduling control 402 is that a scheduling notification should be adopted by the memory controllers 206. The central scheduling control 402 may stop making notifications if the memory request buffer 208 of one or more memory controllers 206 reaches a threshold level.

The scheduling controls 402 may determine to service the memory requests 222 having the same association 250 before other memory requests 222, which may be associated with a second association 250, or raise the priority of the memory requests 222 having the same association 250 based on receiving one of the notifications described above from the central scheduling control 402.

The central scheduling control 402 may be implemented in software, hardware, or firmware. The central scheduling control 402 may be located on a same die as the processing units 212 or a different die.

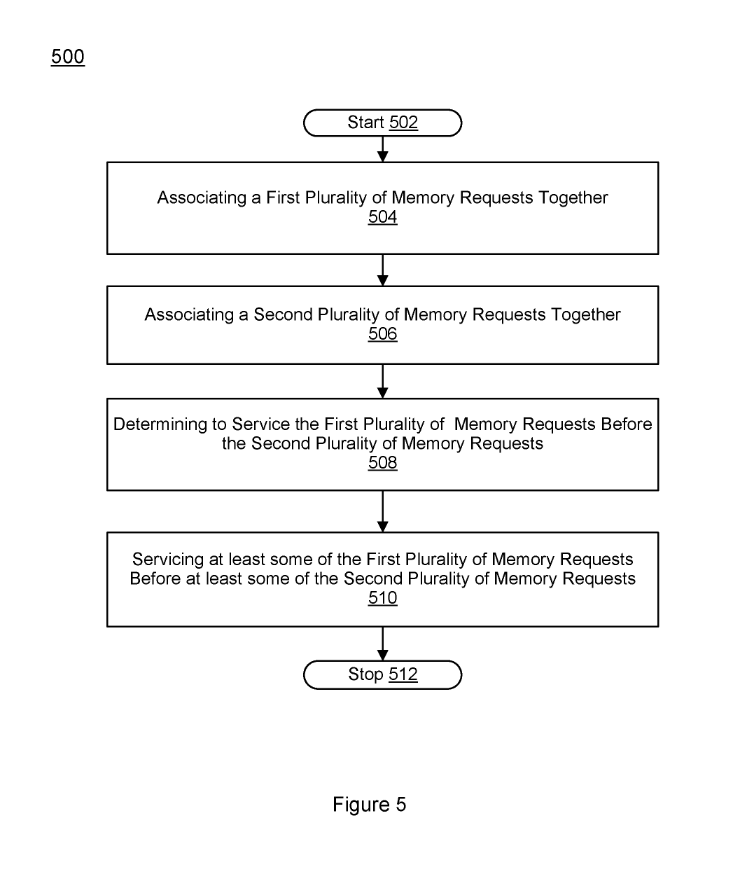

FIG. 5 is a schematic diagram illustrating an example method for reducing memory access time for parallel processors. The method 500 may begin with start 502. The method 500 may continue with associating a first plurality of memory requests together 504. For example, referring to FIG. 2, the processing unit 212.1 may set a first value for association 250 for the memory requests 222.1 through 222.8. The method 500 may continue with associating a second plurality of memory requests together 506. For example, referring to FIG. 2, the processing unit 212.2 may set a second value for association 250 for the memory requests 222.9 through 222.16. The method 500 may continue with determining to service the first plurality of memory requests before the second plurality of memory requests. For example, referring to FIG. 2, the memory requests 222.1 through 222.8, and the memory requests 222.9 through 222.16 may be placed in memory request buffer 208. The scheduling control 210 may determine that there would be more row misses in servicing memory requests 222.9 through 222.16 so the scheduling control 210 may determine to service all of the memory requests 222.1 through 222.8 before the memory requests 222.9 through 222.16.

The method 500 may continue with servicing at least some of the first plurality of memory requests before at least some of the second plurality of memory requests 510. For example, referring to FIG. 2, the memory controller 206 may service at least some of the memory requests 222.1 through 222.8 before 222.9 through 222.16. The method 500 continues with stop 512.

Examples of the disclosed embodiments have the advantage that processing units 212 may not have to wait as long to proceed to the next instruction because at least some of the memory requests 222 associated with the processing units 212 may be serviced ahead of other memory requests 222.

Examples of the disclosed embodiments have the advantage that a memory request 222 that may be delayed because it would cause a row miss, may be serviced sooner because the memory request 222 is part of an association 250 of memory requests 222 and other memory requests 222 of the association 250 have already been serviced. In this way, the processing units 212 may proceed to a next instruction sooner.

Examples of the disclosed embodiments have the following advantage. A memory request 222 that is part of an association 250 may be in a busier memory request buffer 208 than other memory requests of the association 250. The memory request 222 may then be serviced sooner since the memory request is part of the association 250 and other memory requests 222 of the association have already been serviced.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a graphics processing unit (GPU), a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the disclosed embodiments.

The methods or flow charts provided herein may be implemented in a computer program, software, or firmware incorporated in a computer-readable storage medium for execution by a general purpose computer or a processor. In some embodiments, the computer-readable storage medium is non-transitory computer—readable storage medium. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of servicing memory requests, the method comprising:
associating a first plurality of memory requests together, wherein each of the first plurality of memory requests is generated by a corresponding one of a first plurality of processors, and wherein each of the first plurality of processors is executing a first same instruction;
associating a second plurality of memory requests together, wherein each of the second plurality of memory requests is generated by a corresponding one of a second plurality of processors, and wherein each of the second plurality of processors is executing a second same instruction;
determining to service the first plurality of memory requests before the second plurality of memory requests; and
servicing at least some of the first plurality of memory requests before at least some of the second plurality of memory requests based on the determination.

2. The method of claim 1, wherein determining comprises:
determining to service the first plurality of memory requests before the second plurality of memory requests by setting a first priority of the first plurality of memory requests higher than a second priority of the second plurality of memory requests; and
wherein servicing comprises:
servicing at least some of the first plurality of memory requests before at least some of the second plurality of memory requests based on the determination by comparing the first priority with the second priority.

3. The method of claim 1, wherein determining comprises:
determining to service the first plurality of memory requests before at least two of the second plurality of memory requests; and wherein servicing comprises:
servicing at least some of the first plurality of memory requests before at least two of the second plurality of memory requests based on the determination.

4. The method of claim 1, wherein determining comprises:
determining to service the first plurality of memory requests before the second plurality of memory requests based on a first number of the first plurality of memory requests compared with a second number of the second plurality of memory requests.

5. The method of claim 1, wherein the determining comprises:
determining to service the first plurality of memory requests before the second plurality of memory requests based on at least one of: the first plurality of memory requests being below a threshold number and the second plurality of memory requests being above that threshold; a first number of row hits of the first plurality of memory requests being greater than a second number of row hits for the second plurality of memory requests; the first number of row hits of the first plurality of memory requests being approximately equal to a second number of row hits for the second plurality of memory requests, and an age of the first plurality of memory requests being older than a second age of the second plurality of memory requests; a first estimate of a time to service the first plurality of memory requests being less than a second estimated time to service the second plurality of memory requests; a first time in a memory request buffer for the first plurality of memory requests compared with a second time in the memory request buffer for the second plurality of memory requests; and, most of the first plurality of memory requests having been serviced.

6. The method of claim 1, wherein the first plurality of memory requests and the second plurality of memory request are stored in a same memory request buffer of a memory controller.

7. The method of claim 1, further comprising:
splitting the first plurality of memory requests into a first part in a first memory controller and a second part in a second memory controller; wherein, determining comprises:
the first memory controller determining to service the first part of the first plurality of memory requests before the second plurality of memory requests;
the first memory controller notifying the second memory controller of the determination; and, wherein servicing comprises:
the first controller servicing the first part of the first plurality of memory requests before the second plurality of memory requests; and
the second controller servicing the second part of the first plurality of memory requests before the second plurality of memory requests.

8. The method of claim 1, wherein the association of the first plurality of memory requests and the association of the second plurality of memory request is indicated by coupling an association with the memory requests.

9. The method of claim 1, wherein associating further comprising:
a first processing unit associating the first plurality of memory requests together, wherein the processing unit comprises the first plurality of processors; and
a second processing unit associating the second plurality of memory requests together, wherein the processing unit comprises the second plurality of processors.

10. The method of claim 1, wherein each of the first plurality of processors are part of a first single instruction multiple data processing unit (SIMD), and each of the second plurality of processors are part of a second SIMD.

11. The method of claim 1, wherein associating further comprises:
associating the first plurality of memory requests together based on the first plurality of memory requests arriving at a memory controller within a few clock cycles of one another.

12. The method of claim 1, further comprising:
raising a priority of the first plurality of memory requests based on the first plurality of memory requests being associated together.

13. The method of claim 12, wherein determining comprising:
determining to service the first plurality of memory requests before the second plurality of memory requests based on comparing a first priority of the first plurality of memory requests with a second priority of the second plurality of memory requests.

14. The method of claim 1, further comprising:
splitting the first plurality of memory requests into a first part in a first memory controller and a second part in a second memory controller;
a central scheduling control determining to service the first plurality of memory requests before the second plurality of memory requests;
the central scheduling control notifying the first controller and the second controller of the determination;
the first memory controller servicing the first part of the first plurality of memory requests before the second plurality of memory requests based on receiving the notification; and
the second memory controller servicing the second part of the first plurality of memory requests before the second plurality of memory requests based on receiving the notification.

15. The method of claim 1, wherein the first plurality of processors executes a next instruction after each of the plurality of memory requests is satisfied and after each of the plurality of processors completes executing the same instruction.

16. An apparatus for servicing memory requests, the apparatus comprising:
a memory;
a first single instruction multiple data (SIMD) plurality of processors, configured to generate a corresponding first plurality of memory requests;
a second SIMD plurality of processors, configured to generate a corresponding second plurality of memory requests;
a memory controller comprising a memory request buffer configured to store the first plurality of memory requests and the second plurality of memory requests, and configured to service the first plurality of memory requests and the second plurality of memory requests; and
a scheduling control configured to determine whether to service the first plurality of memory requests or the second plurality of memory requests first.

17. The apparatus of claim 16, further comprising:
a second memory controller comprising a second memory request buffer configured to store the first plurality of memory requests and the second plurality of memory requests, and configured to service the first plurality of memory requests and the second plurality of memory requests;
a second scheduling control configured to determine whether to service the first plurality of memory requests or the second plurality of memory requests first; and wherein the second memory controller is configured to notify the memory controller of a second determination by the second scheduling control; and, wherein the memory controller is further configured to:
determine to serve the first plurality of memory requests before the second plurality of memory requests based on receiving the second determination from the second controller.

18. The apparatus of claim 17, wherein the memory controller is further configured to determine to serve the first plurality of memory requests before at least two of the second plurality of memory requests based on receiving the second determination from the second controller.

19. The apparatus of claim 16, further comprising:
a second memory controller comprising a second memory request buffer configured to store the first plurality of memory requests and the second plurality of memory requests, and configured to service the first plurality of memory requests and the second plurality of memory requests;
a central scheduling control configured to determine to service the first plurality of memory requests before the second plurality of memory requests, and configured to notify the controller and the second controller of the determination; wherein the memory controller is configured to serve the first plurality of memory requests before the second plurality of memory requests based on receiving the notification from the central scheduling control; and wherein the second memory controller is configured to serve the first plurality of memory requests before the second plurality of memory requests based on receiving the notification from the central scheduling control.

20. The apparatus of claim 16, wherein the first SIMD plurality of processors is configured to associate the first plurality of memory requests together by setting a first value for an association of the first plurality of memory requests, and wherein the second SIMD plurality of processors is configured to associate the second plurality of memory requests together by setting a second value for an association of the second plurality of memory request.

21. The apparatus of claim 16 wherein the scheduling control is further configured to determine whether to service the first plurality of memory requests or the second plurality of memory requests first based on at least one of: the first plurality of memory requests being below a threshold number and the second plurality of memory request being above the threshold number; a first number of row hits of the first plurality of memory requests being greater than a second number of row hits for the second plurality of memory requests; the first number of row hits of the first plurality of memory requests being approximately equal to a second number of row hits for the second plurality of memory requests, and an age of the first plurality of memory requests being older than a second age of the second plurality of memory requests; a first estimate of a time to service the first plurality of memory requests being less than a second estimated time to service the second plurality of memory requests; a first time in a memory request buffer for the first plurality of memory requests compared with a second time in the memory request buffer for the second plurality of memory requests; or, most of the first plurality of memory requests having been serviced.

22. The apparatus of claim 16 further comprising a clock; and wherein the memory controller is further configured to associate the first plurality of memory requests together based on the first plurality of memory requests arriving at the memory controller within a few clock cycles of one another.

23. The apparatus of claim 16 wherein the scheduling control is further configured to determine whether to service the first plurality of memory requests or the second plurality of memory requests first based on a first number of the first plurality of memory requests compared with a second number of the second plurality of memory requests.

24. A computer readable non-transitory medium including instructions which when executed in a processing system cause the processing system to execute a method for servicing memory requests, the method comprising the steps of:
associating a first plurality of memory requests together, wherein each of the first plurality of memory requests is generated by a corresponding one of a first plurality of processors, and wherein each of the first plurality of processors is executing a first same instruction;
associating a second plurality of memory requests together, wherein each of the second plurality of memory requests is generated by a corresponding one of a second plurality of processors, and wherein each of the second plurality of processors is executing a second same instruction;
determining to service the first plurality of memory requests before the second plurality of memory requests; and
servicing at least some of the first plurality of memory requests before at least some of the second plurality of memory requests based on the determination.

25. A method of servicing memory requests, the method comprising:
associating a first plurality of memory requests together, wherein each of the first plurality of memory requests is generated by a corresponding one of a first plurality of processors, and wherein each of the first plurality of processors is executing a first same instruction;
associating a second plurality of memory requests together, wherein each of the second plurality of memory requests is generated by a corresponding one of a second plurality of processors, and wherein each of the second plurality of processors is executing a second same instruction;
determining to service the first plurality of memory requests before the second plurality of memory requests; and
raising a first priority of the first plurality of memory requests higher than a second priority of the second plurality of memory requests based on the determination.

26. The method of claim 24, further comprising:
servicing memory requests of the first plurality of memory requests and of the second plurality of memory requests in an order based on the first priority and the second priority.
